(19) United States
(12) Patent Application Publication
(10) Pub. No.: US 2023/0062678 A1
(43) Pub. Date: Mar. 2, 2023

(54) NOTIFICATION DEVICE

(71) Applicant: Isuzu Motors Limited, Tokyo (JP)

(72) Inventors: Tomoharu AOKI, Fujisawa-shi, Kanagawa (JP); Naoki TAKAHASHI, Fujisawa-shi, Kanagawa (JP); Masashi IMAMURA, Fujisawa-shi, Kanagawa (JP); Yoshihira KANAZAWA, Fujisawa-shi, Kanagawa (JP); Masahiro SEKI, Fujisawa-shi, Kanagawa (JP); Hirotaka UEDA, Fujisawa-shi, Kanagawa (JP)

(73) Assignee: Isuzu Motors Limited, Tokyo (JP)

(21) Appl. No.: 17/795,551

(22) PCT Filed: Jan. 29, 2021
(86) PCT No.: PCT/JP2021/003251

§ 371 Date: Jul. 27, 2022

(30) Foreign Application Priority Data
Jan. 30, 2020 (JP) 2020-013534

(51) Int. Cl. B60W 50/14; B60W 40/02; B60W 40/105

(52) U.S. Cl. CPC B60W 50/14; B60W 40/02; B60W 40/105; B60W 2300/125; B60W 2555/20

(57) ABSTRACT

Disclosed is a notification device that reduces notifications which an occupant would find irritating. This notification device comprises: a notification unit that detects an object approaching a vehicle, and notifies an occupant of the approach of the object; and a notification control unit that is connected to a wiper of the vehicle, determines the quantity of water present in the vehicle surroundings on the basis of a wiper operation quantity, and when the quantity of water is greater than a prescribed threshold value, controls the notification unit such that the degree of notification is suppressed compared to when the quantity of water is less than or equal to the threshold value.

### TECHNICAL FIELD

The present disclosure relates to a notification apparatus.

### BACKGROUND ART

In the related art, a blind spot monitor (BSM) or other notification apparatus that detects objects approaching a vehicle by transmitting, for example, millimeter wave radar around the vehicle and notifies passengers in the vehicle of the approach of the object has been in practical use. Here, the presence of moisture around the vehicle due to rainfall or other factors may reduce the accuracy of object detection.

In view of this, as a technology to improve the detection accuracy of objects, for example, PTL 1 discloses an object detection apparatus that improves the detection accuracy of objects by reducing the influence of the wiper and raindrops.

### CITATION LIST

### Patent Literature

PTL 1
Japanese Patent Application Laid-Open No. 2016-114398

### SUMMARY OF INVENTION

### Technical Problem

However, if the object detection apparatus of PTL 1 mistakenly detects rain as an object, the apparatus may notify passenger of the object's approach over a long period of time of the rain, and the notification may be bothersome to the passenger.

An object of the present disclosure is to provide a notification apparatus that reduces the notification that is bothersome to the passenger.

### Solution to Problem

A notification apparatus according to the present disclosure includes: a notification part configured to detect an object approaching a vehicle and provide a notification of approach of the object to a passenger; and a notification control part connected to a wiper of the vehicle, and configured to determine a moisture amount around the vehicle on a basis of an operation amount of the wiper, the notification control part being configured to control the notification part such that when the moisture amount is greater than a predetermined threshold value, a level of a notification is suppressed than when the moisture amount is equal to or smaller than the predetermined threshold value.

### Advantageous Effects of Invention

According to the present disclosure, the notification that is bothersome to the passenger can be reduced.

### BRIEF DESCRIPTION OF DRAWINGS

FIG. 1 is a diagram illustrating a configuration of a vehicle including a notification apparatus according to an embodiment of the present disclosure;

FIG. 2 is a flowchart illustrating an operation of the present embodiment; and

FIG. 3 is a diagram illustrating a configuration of a modification of the present embodiment.

### DESCRIPTION OF EMBODIMENTS

Embodiments according to the present disclosure are described below with reference to accompanying drawings.

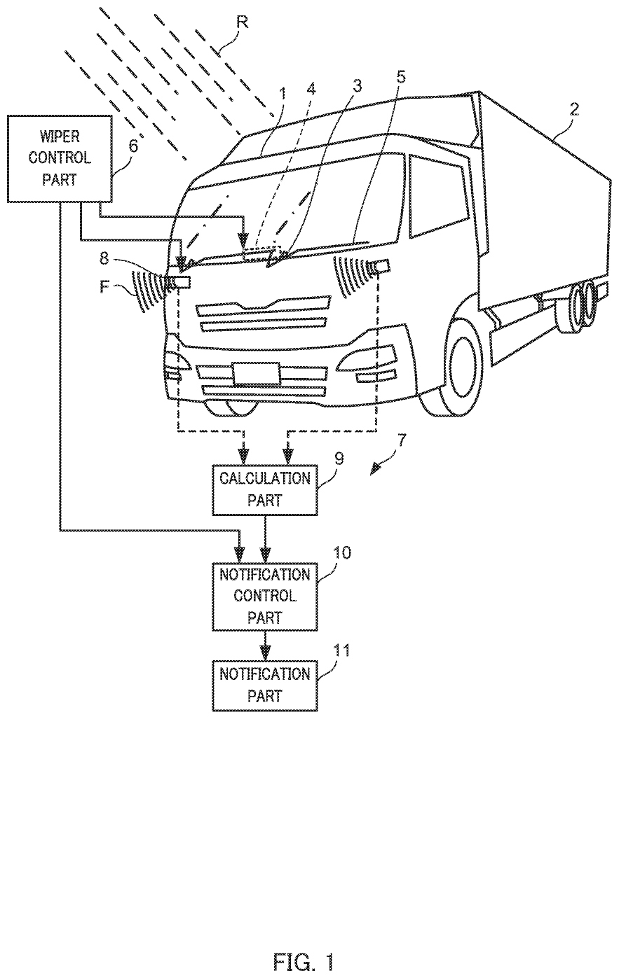

FIG. 1 is a diagram illustrating a configuration of a vehicle including a notification apparatus according to an embodiment of the present disclosure. Vehicle includes cabin 1, loading part 2, washer 3, rain sensor 4, wiper 5, wiper control part 6, and notification apparatus 7. Examples of the vehicle include a commercial vehicle such as a truck.

Cabin 1 is configured for passengers to board, and disposed in the front part of the vehicle. At the driver's seat in cabin 1, an operation part for operating each part of the vehicle is disposed, and, for example, a washer switch for operating washer 3 and a wiper switch for operating wiper 5 are disposed. Loading part 2 is configured to carry load, and is disposed at the rear of the vehicle relative to cabin 1, for example. Loading part 2 is formed in a shape that is long in the vehicle front-rear direction so as to extend from the vicinity of the rear part of cabin 1 to the vehicle rear part.

Washer 3 is configured to wash the windshield of the vehicle, and jets washer fluid onto the windshield in accordance with an operation signal of the washer switch. Subsequently, wiper 5 operates for only a short time under the control of wiper control part 6. Here, the period from jetting of the washer fluid from washer 3 to stop of the operation of wiper 5 is referred to as the operation period of washer 3. Rain sensor 4 is configured to detect rain R that adheres to the vehicle, and is disposed near a lower portion of the windshield. Rain sensor 4 may be of capacitive, optical, or other type for detecting rain R, for example.

Wiper 5 is configured to wipe off rain R adhered to the windshield of the vehicle, and is disposed to operate along the windshield. Wiper control part 6 is connected to wiper 5 and rain sensor 4, and controls the operation of wiper 5 in accordance with an operation signal of the wiper switch provided in the driver's seat in cabin 1. Here, the wiper switch is capable of switching the operation state of wiper 5 between “OFF”, “AUTO”, “low speed” and “high speed”. Further, the wiper switch can switch between “ON” and “OFF” of the automatic wiper in the “AUTO” state.

When the wiper switch is set to “OFF”, wiper control part 6 stops the operation of wiper 5. In addition, when the wiper switch is set to “AUTO” and the automatic wiper is set to “OFF”, wiper control part 6 automatically and intermittently operates wiper 5 at a preliminarily set interval. In addition, when the wiper switch is set to “AUTO” and the automatic wiper is set to “ON”, wiper control part 6 automatically operates wiper 5 at a speed corresponding to the detection amount of rain R detected at rain sensor 4. In addition, when the wiper switch is set to “low speed”, wiper control part 6 operates the wiper at a preliminarily set low speed, whereas when the wiper switch is set to “high speed”, wiper control part 6 operates the wiper at a speed faster than “low speed”.

Notification apparatus 7 includes a pair of detection parts 8 disposed in the front part of cabin 1, and calculation part 9, notification control part 10 and notification part 11 are sequentially connected to the pair of detection parts 8. In addition, notification control part 10 is also connected to wiper control part 6. Notification apparatus 7 may be composed of a blind spot monitor, for example.

Detection part 8 is configured to detect an object located around the vehicle, and is disposed in the vicinity of the right side part and the vicinity of the left side part in the front part of cabin 1. Detection part 8 may be composed of a millimeter-wave radar that detects an object by transmitting and receiving millimeter waves, for example. Detection part 8 includes a detection surface oriented toward the vehicle front side, transmits and receives millimeter wave F from the detection surface, and detects the object present in the detection range extending in the front of the detection surface. Detection part 8 is formed to have the detection range of 150 degrees in front of the detection surface, for example.

Calculation part 9 calculates the position of the object on the basis of the detection information of detection part 8. Then, calculation part 9 determines whether the position of the object is less than or equal to a predetermined distance from the vehicle, and, when it is at equal to or smaller than the predetermined distance, calculation part 9 outputs an approach signal to notification control part 10.

Notification control part 10 controls notification part 11 so as to provide the notification of the approach of the object on the basis of the approach signal output from calculation part 9. Here, notification control part 10 acquires the operation information of wiper 5 from wiper control part 6, and determines the amount of rain R falling around the vehicle on the basis of the operation amount of wiper 5.

More specifically, notification control part 10 determines the amount of rain R on the basis of the number of times wiper 5 operates in a predetermined period. For example, notification control part 10 can count the number of times wiper 5 is operated on the basis of the number of times the operation signal for operating wiper 5 is output by wiper control part 6. Then, when the determined amount of rain R is greater than the predetermined threshold value, notification control part 10 controls notification part 11 so as to suppress the level of the notification than when the case where the amount of rain R is equal to or smaller than the predetermined threshold value. That is, even when an approach signal is output from calculation part 9, the level of the notification is suppressed when the determined amount of rain R is greater than the predetermined threshold value.

For example, notification control part 10 can set a predetermined threshold value on the basis of the detection accuracy of detection part 8 for the amount of rain R. For example, notification control part 10 can set a predetermined threshold value for the amount of rain R for which the detection accuracy of detection part 8 is largely reduced.

Notification part 11 is disposed in the vehicle interior of cabin 1, and provides the notification of the approach of the object to the passenger in cabin 1 under the control of notification control part 10.

Note that the function of notification apparatus 7 can be implemented with a computer program. For example, the reading apparatus of the computer reads a program for achieving the function of notification apparatus 7 from a recording medium in which the program is recorded, and stores it in the storage apparatus. Then, the CPU copies, in the RAM, the program stored in the storage apparatus, sequentially reads the command included in the program from the RAM and executes it, and thus, the function of notification apparatus 7 can be achieved.

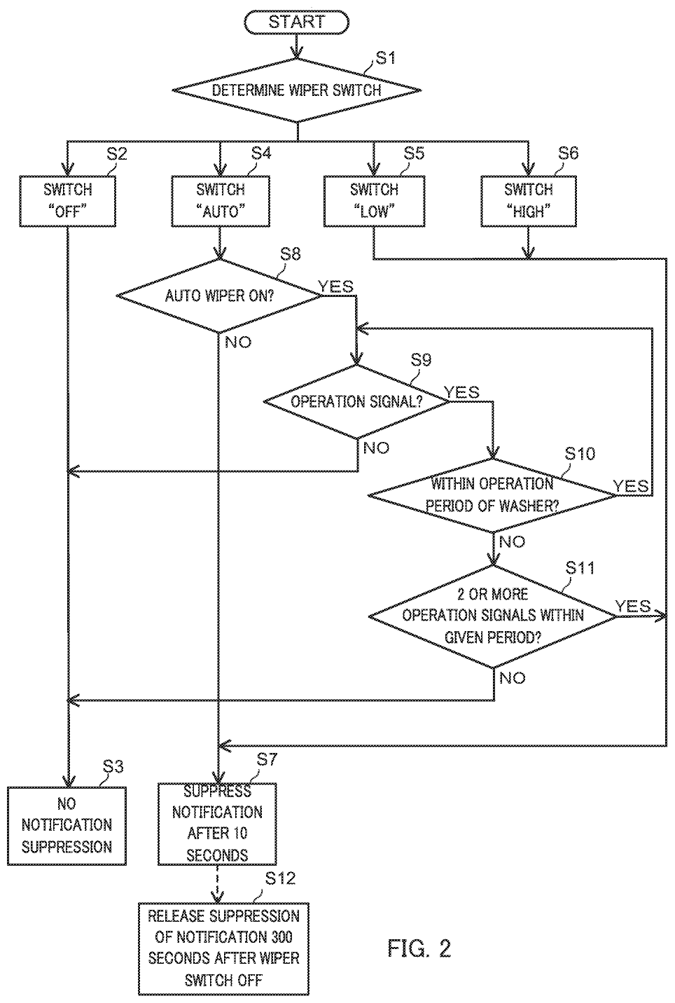

Next, an operation of the present embodiment is described with reference to the flowchart of FIG. 2.

First, as illustrated in FIG. 1, the driver operates the vehicle by operating the operation part. At this time, the driver operates the wiper switch not illustrated in the drawing in accordance with the state of rain R. This operation signal is input to wiper control part 6, and wiper control part 6 operates wiper 5 on the basis of the operation signal. In addition, wiper control part 6 outputs the state of the wiper switch to notification control part 10 as the operation information of wiper 5.

On the other hand, detection part 8 transmits and receives millimeter wave F, and this reception signal is output to calculation part 9. At this time, when an object is present around the vehicle, millimeter wave F reflected by the object is received by detection part 8 in a short time, and a reception signal including the detection information of the object is output to calculation part 9.

Calculation part 9 acquires detection information from the reception signal sequentially output from detection part 8, and calculates the position of the object with respect to the vehicle on the basis of the detection information. Subsequently, calculation part 9 determines whether the position of the object is less than or equal to a predetermined distance from the vehicle, and when it is equal to or smaller than the predetermined distance, it is determined that an object is approaching the vehicle, and, an approach signal is output to notification control part 10.

Subsequently, when the approach signal indicating the approach of the object is input from calculation part 9, notification control part 10 controls notification part 11 on the basis of the operation amount of wiper 5 by wiper control part 6. More specifically, at step S1, notification control part 10 determines the state of the wiper switch on the basis of the state information of the wiper switch output from wiper control part 6. When the state of the wiper switch is in the “OFF” state, notification control part 10 advances the process to step S2, sets the number of times wiper 5 operates in a predetermined period to zero, and determines that there is no rain R falling, i.e., the amount of rain R is equal to or smaller than the predetermined threshold value. At this time, when the approach signal is input from calculation part 9, notification control part 10 advances the process to step S3, and controls notification part 11 so as to provide the notification of the approach of the object at the normal degree without suppressing the level of the notification for the passenger. This allows the passenger to recognize the approaching object and stop the vehicle, etc., to prevent the object from colliding with the vehicle.

Here, notification control part 10 is connected to the washer switch for operating washer 3 through wiper control part 6, and, when the washer switch is operated by the driver, its operation signal is input thereto. When the operation state of wiper 5 is in the “OFF” state and an operation signal is input from the washer switch, notification control part 10 stops the counting of the number of times wiper 5 is operated, i.e., stops the determination of the amount of rain R in the operation period of washer 3. In this manner, it is possible to suppress a situation where when there is no rain R falling, notification control part 10 erroneously determines that there is rain R falling and provides a notification due to the operation of washer 3.

Subsequently, when the driver operating the vehicle switches the wiper switch, notification control part 10 again determines the state of the wiper switch at step S1. When the state of the wiper switch is “AUTO”, notification control part 10 advances the process to step S4. When the state of the wiper switch is “low speed”, notification control part 10 advances the process to step S5. When the state of the wiper switch is “high speed”, notification control part 10 advances the process to step S6.

When the process is advanced to steps S5 and S6, notification control part 10 determines that the number of times wiper 5 operates in a predetermined period is large, i.e., the amount of rain R affects the detection accuracy of detection part 8, and that the amount of rain R is greater than the predetermined threshold value. Subsequently, notification control part 10 advances the process to step S7, and controls notification part 11 so as to suppress the level of the notification for the passenger than when the amount of rain R is equal to or smaller than the predetermined threshold value. That is, notification control part 10 controls notification part 11 so as to suppress the level of the notification also when an approach signal is input from calculation part 9.

In general, when there is rain R falling around the vehicle, the detection accuracy of detection part 8 tends to decrease to a certain degree, and there is a risk of detecting rain R as an object. In the related art, when the detection part detects an object, the notification of the approach of the object is provided to the passenger also when there is rain R falling around the vehicle as when there is no rain R falling. As such, when the detection part erroneously detects rain R as an object, there is a risk of providing the notification to the passenger even though there is no object while there is rain R falling.

In view of this, when the amount of rain R is greater than the predetermined threshold value, notification control part 10 suppresses the level of the notification for the passenger. In this manner, when detection part 8 erroneously detects rain R as the object, a situation where the notification based on the detection error is provided over a long period of rain R can be suppressed and the passenger's annoyance can be reduced.

At this time, notification control part 10 controls notification part 11 so as to suppress the level of the notification approximately 10 seconds after the start of the operation of wiper 5, i.e., after the wiper switch is switched. In this manner, for example, a situation where the level of the notification is suppressed when the driver erroneously operates the wiper switch can be prevented. Note that the elapse of the 10 seconds is not limitative, and it suffices that notification control part 10 controls notification part 11 so as to suppress the level of the notification after a predetermined suppression waiting time has elapsed after the start of the operation of wiper 5.

On the other hand, when notification control part 10 advances the process to step S4, it determines whether the automatic wiper is in the “ON” state at step S8. Here, when the automatic wiper is not in the “ON” state, i.e., when it is in the “OFF” state, wiper control part 6 automatically and intermittently operates wiper 5 at a preliminarily set interval. When notification control part 10 determines that the automatic wiper is not in the “ON” state, it determines that the number of times wiper 5 operates in a predetermined period is large, i.e., the amount of rain R affects the detection accuracy of detection part 8, and that the amount of rain R is greater than the predetermined threshold value. Subsequently, notification control part 10 advances the process to step S7, and it controls notification part 11 so as to suppress the level of the notification for the passenger than when the amount of rain R is equal to or smaller than the predetermined threshold value, approximately 10 seconds after the start of the operation of wiper 5. That is, notification control part 10 controls notification part 11 so as to suppress the level of the notification also when an approach signal is input from calculation part 9.

In addition, at step S8, when notification control part 10 determines that the automatic wiper is in the “ON” state, it advances the process to step S9 to determine whether the operation signal is output to wiper 5 from wiper control part 6, i.e., whether wiper 5 is operated. Here, it is set such that when the automatic wiper is in the “ON” state, wiper control part 6 automatically operates wiper 5 at a speed corresponding to the detection amount of rain R detected at rain sensor 4.

When the operation signal is not output to wiper 5 from wiper control part 6, the number of times wiper 5 operates in a predetermined period is zero, and therefore notification control part 10 determines that there is no rain R falling, i.e., the amount of rain R is equal to or smaller than the predetermined threshold value. In this manner, notification control part 10 advances the process to step S3, and controls notification part 11 so as to provide the notification at the normal degree without suppressing the level of the notification.

On the other hand, when the operation signal is output to wiper 5 from wiper control part 6, notification control part 10 advances the process to step S10, and determines whether the operation of wiper 5 is within the operation period of washer 3. When the operation of wiper 5 is within the operation period of washer 3, notification control part 10 stops the counting of the number of times wiper 5 is operated, i.e., stops the determination of the amount of rain R, and the process is returned to step S9. Then, until it is determined that the operation of wiper 5 is not within the operation period of washer 3, the processes of steps S9 and S10 are repeated.

In general, the windshield of a commercial vehicle such as a truck is disposed at a steep, almost vertical angle, and is therefore prone to dirt adhesion. As such, the driver washes the windshield with washer 3 more often, increasing the likelihood that rain sensor 4 will erroneously detect washer fluid as rain R. When notification control part 10 counts the number of times wiper 5 is operated due to detection errors of rain sensor 4, the level of the notification for the passenger is suppressed even when there is no rain R falling. In view of this, by determining whether the operation of wiper 5 is within the operation period of washer 3 by notification control part 10, the suppression of the notification based on the detection error can be reduced.

When the operation of wiper 5 is not within the operation period of the washer fluid, notification control part 10 advances the process to step S11, and determines whether there are two or more operation signals of wiper 5 within a predetermined period. When there is one or less operation signal of wiper 5 within a predetermined period, notification control part 10 determines that the number of times wiper 5 operates in a predetermined period is small, i.e., the amount of rain R does not affect the detection accuracy of detection part 8, and that the amount of rain R is equal to or smaller than the predetermined threshold value. In this manner, notification control part 10 advances the process to step S3, and controls notification part 11 so as to provide the notification at the normal degree without suppressing the level of the notification.

On the other hand, when there are two or more operation signals of wiper 5 within a predetermined period, notification control part 10 determines that the number of times wiper 5 operates in a predetermined period is large, i.e., the amount of rain R affects the detection accuracy of detection part 8, and that the amount of rain R is greater than the predetermined threshold value. In this manner, at step S7, notification control part 10 controls notification part 11 so as to suppress the level of the notification for the passenger approximately 10 seconds after the start of the operation of wiper 5.

As described above, since notification control part 10 controls notification part 11 so as to suppress the level of the notification when the amount of rain R is greater than the predetermined threshold value, a situation where the notification based on the detection error is continued over a long period of rain R when detection part 8 erroneously detects rain R as the object can be suppressed, and the passenger's annoyance can be reduced. In addition, since notification control part 10 determines the moisture amount on the basis of the number of times wiper 5 operates in a predetermined period, the amount of rain R can be reliably determined in comparison with a configuration of mechanically detecting rain R with only a capacitance sensor or the like, for example.

Here, in the case where notification part 11 provides the notification in the form of speaker sound and lamp light, notification control part 10 may control notification part 11 so as to reduce the volume of the speaker and light quantity of the lamp to a predetermined degree, for example. In addition, notification control part 10 may control notification part 11 so as to suppress the notification by stopping the notification of the speaker and performing only the notification of the lamp. In addition, notification control part 10 may suppress the notification by stopping all notifications.

In addition, notification control part 10 may control notification part 11 so as to suppress the level of the notification stepwise in accordance with the amount of rain R. That is, notification control part 10 controls notification part 11 such that the greater the number of times wiper 5 is operated in a predetermined period, the lower the level of the notification stepwise. In this manner, the notification that is bothersome to the passenger can be appropriately reduced.

In this manner, at step S7, notification control part 10 suppresses the level of the notification of notification part 11 until the wiper switch is switched.

Subsequently, on the basis of the state information of the wiper switch output from wiper control part 6, notification control part 10 sequentially determines the switching of the wiper switch. When determining that the wiper switch is switched “OFF”, notification control part 10 advances the process to step S12, and releases the suppression of the notification after approximately 300 seconds have elapsed after the wiper switch is switched “OFF”, i.e., after the operation of wiper 5 is stopped.

In this manner, notification control part 10 can maintain the suppression of the notification for about 300 seconds until the rain R on the detection part 8 dries up, and can release the suppression of the notification after the rain R dries up. In this manner, detection part 8 can suppress the detection errors and can reliably detect the object.

Note that the elapse of 300 seconds is not limitative, and it suffices that notification control part 10 releases the suppression of the notification after a predetermined release waiting time has elapsed after the stop of wiper 5. For example, notification control part 10 may change the predetermined release waiting time in accordance with the travel speed of the vehicle. Specifically, when the travel speed of the vehicle is high, the release waiting time may be shortened than when the travel speed is low. In addition, notification control part 10 may change the predetermined release waiting time in accordance with the external environment of vehicle outside such as temperature and humidity. In this manner, the object can be more reliably detected while suppressing detection errors of detection part 8.

According to the present embodiment, notification control part 10 determines the amount of rain R on the basis of the number of times wiper 5 operates in a predetermined period, and controls notification part 11 so as to suppress the level of the notification than when the case where the amount of rain R is equal to or smaller than the predetermined threshold value when the amount of rain R is greater than the predetermined threshold value. In this manner, a situation where the notification based on the detection error is continued over a long period of rain R can be suppressed, and the notification that is bothersome to the passenger can be reduced.

Note that while notification control part 10 determines the amount of rain R on the basis of the number of times wiper 5 operates in a predetermined period in the above-described Embodiment, the present invention is not limited to this as long as it is determined on the basis of the operation amount of wiper 5. For example, notification control part 10 may make the determination on the basis of the speed, power consumption amount and the like of wiper 5.

In addition, notification control part 10 suppresses the notification when the amount of rain R is relatively small, e.g., when the state of the wiper switch is “low speed” in the above-described Embodiment, the present invention is not limited to this, and it suffices that the notification is suppressed when the amount of rain R is greater than the predetermined threshold value. For example, notification control part 10 may suppress the notification when the state of the wiper switch is “high speed” and may provide the notification at the normal degree without suppressing the level of the notification when the state of the wiper switch is “low speed”.

In addition, while notification control part 10 determines the amount of rain R in the above-described Embodiment, rain R is not limitative as long as the moisture amount around the vehicle can be determined. For example, notification control part 10 may determine fog, snow and the like around the vehicle.

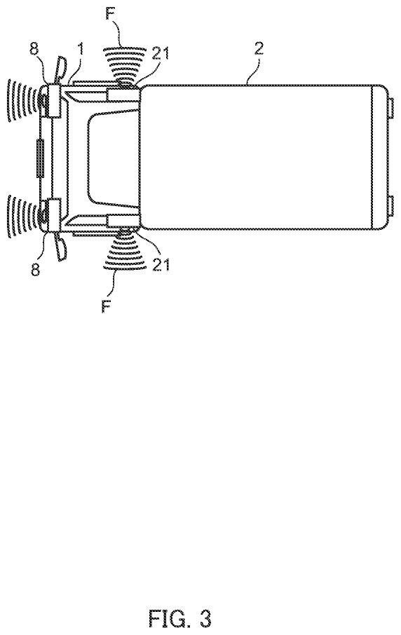

In addition, while detection part 8 is disposed in the vicinity of the right side part and the vicinity of left side part in the front part of cabin 1 in the above-described Embodiment, the present invention is not limited to this as long as an object approaching a vehicle can be detected. In addition, one detection part 8, or three or more detection parts 8 may be disposed. For example, as illustrated in FIG. 3, a pair of detection parts 21 may be additionally disposed separately from the pair of detection parts 8 of the above-described Embodiment. The pair of detection parts 21 has a configuration similar to that of detection part 8, and is disposed in the vicinity of the right side part and the vicinity of the left side part in the rear part of cabin 1. Detection part 21 includes the detection surface oriented to the right lateral side and the left lateral side of the vehicle, transmits and receives millimeter wave F from the detection surface, and detects the object present in the detection range extending in the front of the detection surface. In this manner, objects can be detected in a wide range from the vehicle front side to the vehicle lateral side.

In addition, while detection part 8 is composed of a millimeter-wave radar in the above-described Embodiment, the present invention is not limited to this as long as an object approaching a vehicle can be detected. For example, detection part 8 may be composed of an ultrasound sensor, a laser radar, a camera, or the like. It should be noted that detection part 8 is preferably composed of a millimeter-wave radar from a view point of rectilinearity and the like.

In addition, while loading part 2 is disposed to carry a load in the above-described Embodiment, the present invention is not limited to this as long as it is disposed at the rear of the vehicle relative to cabin 1.

The above-mentioned embodiments are merely examples of embodiments for implementing the invention, and the technical scope of the invention should not be interpreted as limited by these embodiments. In other words, the invention can be implemented in various forms without deviating from its gist or its main features. For example, the disclosure of the shape and number of each part described in the above form is only an example and can be changed and implemented as appropriate.

This application is entitled to and claims the benefit of Japanese Patent Application No. 2020-013534 filed on Jan. 30, 2020, the disclosure each of which including the specification, drawings and abstract is incorporated herein by reference in its entirety.

### INDUSTRIAL APPLICABILITY

The notification apparatus according to the present disclosure can be used for an apparatus that detects an object approaching a vehicle and provides the notification of the approach of the object to the passenger.

### REFERENCE SIGNS LIST

1 Cabin
2 Loading part
3 Washer
4 Rain sensor
5 Wiper
6 Wiper control part
7 Notification apparatus
8, 21 Detection part
9 Calculation part
10 Notification control part
11 Notification part
F Millimeter wave
R Rain

1. A notification apparatus comprising:
a notification part configured to detect an object approaching a vehicle and provide a notification of approach of the object to a passenger; and
a notification control part connected to a wiper of the vehicle, and configured to determine a moisture amount around the vehicle on a basis of an operation amount of the wiper, the notification control part being configured to control the notification part such that when the moisture amount is greater than a predetermined threshold value, a level of a notification is suppressed than when the moisture amount is equal to or smaller than the predetermined threshold value.

2. The notification apparatus according to claim 1, wherein the notification control part determines the moisture amount on a basis of a number of times the wiper operates in a predetermined period.

3. The notification apparatus according to claim 1, wherein when a washer for washing a windshield is operated in a state where an operation state of the wiper is OFF, the notification control part stops determination of the moisture amount in an operation period of the washer.

4. The notification apparatus according to claim 1, wherein when the wiper is operated in a state where an operation state of the wiper is an automatic wiper for automatically operating the wiper, the notification control part determines whether an operation of the wiper is within an operation period of a washer for washing a windshield, and the notification control part stops determination of the moisture amount when the operation of the wiper is within the operation period.

5. The notification apparatus according to claim 1, wherein when the moisture amount is greater than the predetermined threshold value, the notification control part controls the notification part so as to suppress the level of the notification when a predetermined suppression waiting time has elapsed after an operation of the wiper is started.

6. The notification apparatus according to claim 1, wherein when an operation of the wiper is stopped after the level of the notification of the notification part is suppressed, the notification control part releases suppression of the notification when a predetermined release waiting time has elapsed after the wiper is stopped.

7. The notification apparatus according to claim 6, wherein the notification control part changes the predetermined release waiting time in accordance with a travel speed of the vehicle.
